(19) United States
(12) Patent Application Publication
(10) Pub. No.: US 2017/0083220 A1
(43) Pub. Date: Mar. 23, 2017

(54) METHOD AND APPARATUS FOR CONTROLLING DEVICES

(71) Applicant: Xiaomi Inc., Beijing (CN)

(72) Inventors: Sitai GAO, Beijing (CN); Weiguang JIA, Beijing (CN); Enxing HOU, Beijing (CN)

(73) Assignee: Xiaomi Inc., Beijing (CN)

(21) Appl. No.: 15/088,900

(22) Filed: Apr. 1, 2016

(30) Foreign Application Priority Data
Sep. 18, 2015 (CN) 201510601095.7

(51) Int. Cl. G06F 3/0484; G05B 19/10; H04L 12/28; G05B 19/042

(52) U.S. Cl. CPC G06F 3/04847; G06F 3/04842; G05B 19/042; G05B 19/106; H04L 12/282; G05B 2219/2642

(57) ABSTRACT

Aspects of the disclosure provide a method for controlling devices that includes: in response to an occurrence of an event in a mobile terminal, determining whether the event corresponds to a starting condition for adopting a control scene; when a determination indicates that the event corresponds to the starting condition for adopting the control scene, identifying one or more devices for executing one or more tasks in accordance with the control scene; and controlling the identified one or more devices to execute the one or more tasks in accordance with the control scene.

### CROSS-REFERENCE TO RELATED APPLICATION

This application claims priority to Chinese Patent Application No. 201510601095.7, filed Sep. 18, 2015, which is incorporated herein by reference in its entirety.

### FIELD

The present disclosure generally relates to the field of smart home, and more particularly to method and apparatus for controlling devices.

### BACKGROUND

In many applications, various types of devices, such as a smart phone, television, stereo, air-condition, purifier, router, and the like, are used in a home environment for assisting users for enhanced convenience and enjoyment.

In order to use these devices, each of the devices is generally configured with corresponding controls or remote control for the users, through which the users can activate and control these devices.

In many applications when there are multiple devices used in the same house, every device still operates independently, and the activation and control of every device still needs to be performed manually on a device-by-device basis.

### SUMMARY

Aspects of the disclosure provide a method for controlling devices that includes: in response to an occurrence of an event in a mobile terminal, determining whether the event corresponds to a starting condition for adopting a control scene; when a determination indicates that the event corresponds to the starting condition for adopting the control scene, identifying one or more devices for executing one or more tasks in accordance with the control scene; and controlling the identified one or more devices to execute the one or more tasks in accordance with the control scene.

In at least one embodiment, controlling the identified one or more devices to execute the one or more tasks in accordance with the control scene includes: generating an executing instruction for a task of the one or more tasks in accordance with the control scene; and sending the executing instruction to at least one corresponding device of the identified one or more devices, wherein the executing instruction is used to trigger execution of the task by the at least one corresponding device in accordance with the control scene.

In at least one embodiment, the method for controlling devices further includes receiving a user input regarding selecting an event from a plurality of candidate events; setting in the control scene the selected event as the starting condition for the control scene; receiving a user input regarding selecting a task from a plurality of candidate tasks; and setting in the control scene the selected task as a task associated with the starting condition.

Aspects of the disclosure provide a method for controlling an apparatus that includes: receiving a signal sent by a starting device; determining whether the signal indicates that the starting device satisfies a starting condition for adopting a control scene; and when a determination indicates that the starting device satisfies the starting condition for adopting the control scene, executing a task by the apparatus in accordance with the control scene.

In at least one embodiment, the signal indicates a parameter for determining an occurrence of an event in the starting device, the starting condition for adopting the control scene corresponds to one or more events that include starting up, shutting off, restarting, starting a refrigeration mode, starting a heating mode, detecting someone entering, or detecting someone leaving, and determining whether the signal indicates that the starting device satisfies the starting condition for adopting the control scene comprises determining whether the event corresponds to the starting condition for adopting the control scene.

Aspects of the disclosure provide an apparatus for controlling devices that includes a processor and a memory for storing processor-executable instructions. The processor is configured to: in response to an occurrence of an event in a mobile terminal, determine whether the event corresponds to a starting condition for adopting a control scene; when a determination indicates that the event corresponds to the starting condition for adopting the control scene, identify one or more devices for executing one or more tasks in accordance with the control scene; and control the identified one or more devices to execute the one or more tasks in accordance with the control scene.

In at least one embodiment, the processor is further configured to: generate an executing instruction for a task of the one or more tasks in accordance with the control scene; and send the executing instruction to at least one corresponding device of the identified one or more devices. The executing instruction is used to trigger execution of the task by the at least one corresponding device in accordance with the control scene.

In at least one embodiment, the processor is further configured to: receive a user input regarding selecting an event from a plurality of candidate events; set in the control scene the selected event as the starting condition for the control scene; receive a user input regarding selecting a task from a plurality of candidate tasks; and set in the control scene the selected task as a task associated with the starting condition.

Aspects of the disclosure provide an apparatus that includes a processor and a memory for storing processor-executable instructions. The processor is configured to: receive a signal sent by a starting device; determine whether the signal indicates that the starting device satisfies a starting condition for adopting a control scene; and when a determination indicates that the starting device satisfies the starting condition for adopting the control scene, execute a task by the apparatus in accordance with the control scene.

In at least one embodiment, the signal indicates a parameter for determining an occurrence of an event in the starting device, the starting condition for adopting the control scene corresponds to one or more events that include starting up, shutting off, restarting, starting a refrigeration mode, starting a heating mode, detecting someone entering, or detecting someone leaving, and when determining whether the signal indicates that the starting device satisfies the starting condition for adopting the control scene, the processor is further configured to determine whether the event corresponds to the starting condition for adopting the control scene.

In at least one embodiment, the processor is further configured to: receive a user input regarding selecting an event from a plurality of candidate events; set in the control scene the selected event as the starting condition for the control scene; receive a user input regarding selecting a task from a plurality of candidate tasks; and set in the control scene the selected task as a task associated with the starting condition.

### BRIEF DESCRIPTION OF THE DRAWINGS

The accompanying drawings, which are incorporated in and constitute a part of this specification, illustrate embodiments consistent with the disclosure and, together with the description, serve to explain the principles of various embodiments in the disclosure.

FIG. 1 is a diagram of a smart home scenario according to an example embodiment of the disclosure;

FIG. 2 is a flow chart illustrating a method for controlling devices according to an example embodiment of the disclosure;

FIG. 3A is a flow chart illustrating a method for controlling devices according to another example embodiment of the disclosure;

FIG. 3B is a flow chart illustrating a method for configuring a control scene according to an example embodiment of the disclosure;

FIG. 3C is a diagram illustrating a user interface for configuring a control scene according to an example embodiment of the disclosure;

FIG. 3D is a diagram illustrating a user interface for setting a starting condition in a control scene according to an example embodiment of the disclosure;

FIG. 3E is a diagram illustrating a user interface for setting a task in a control scene according to an example embodiment of the disclosure;

FIG. 4 is a flow chart illustrating a method for executing a task in accordance with a control scene according to another example embodiment of the disclosure;

FIG. 5A is a flow chart illustrating a method for executing a task in accordance with a control scene according to another example embodiment of the disclosure;

FIG. 5B is a flow chart illustrating a method for configuring a control scene according to another example embodiment of the disclosure;

FIG. 5C is a diagram illustrating a user interface for setting a starting condition in a control scene according to another exemplary embodiment;

FIG. 5D is a schematic diagram illustrating a setting interface for setting a task in a control scene according to another example embodiment of the disclosure;

FIG. 6A is a block diagram illustrating an apparatus for controlling devices according to an example embodiment of the disclosure;

FIG. 6B is a block diagram illustrating an apparatus for controlling devices according to another example embodiment of the disclosure;

FIG. 7A is a block diagram illustrating an apparatus for executing a task in accordance with a control scene according to another example embodiment of the disclosure;

FIG. 7B is a block diagram illustrating an apparatus for executing a task in accordance with a control scene according to another example embodiment of the disclosure;

FIG. 8 is a block diagram illustrating an example apparatus according to an example embodiment of the disclosure;

FIG. 9 is a block diagram illustrating another example apparatus according to another example embodiment of the disclosure.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the disclosure. Instead, they are merely examples of apparatuses and methods consistent with aspects related to the disclosure as recited in the appended claims.

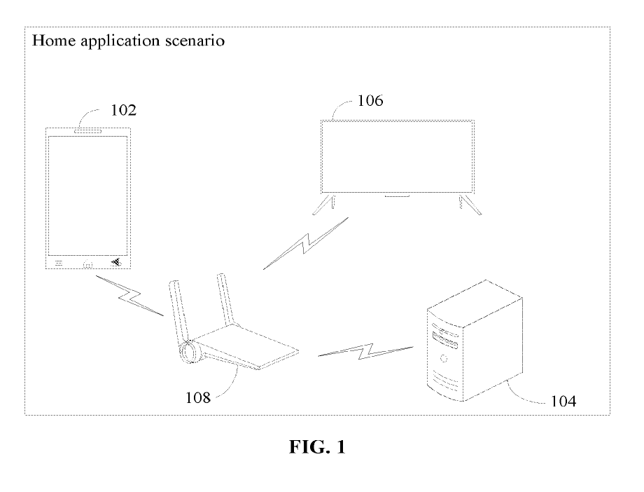

FIG. 1 is a diagram of a smart home scenario according to an example embodiment of the disclosure. As shown in FIG. 1, the home application scenario may include a mobile terminal such as a smart phone 102, a sever 104, and a smart device 106.

The smart phone 102 is connected to the sever 104 over wireless network, the wireless network may the WLAN (Wireless Local Area Network) WiFi (Wireless Fidelity) based on IEEE 802.11b standard, or mobile network.

In some embodiments, when the smart phone 102 is connected to the sever 104 over WiFi, the smart phone 102 may also be interconnected to the other smart devices 106.

In some embodiments, the smart phone 102 may also be interconnected to the other smart devices 106 over the forms of Bluetooth or NFC (Near Field Communication).

In some embodiments, the smart home client (an application program) may be installed in the smart phone 102, the user may login the sever 104 with the user account registered successfully in the smart home client. In some embodiments, the user may also install the smart home client into the other smart devices, the user may login the user account on the smart device which has been installed the smart home client.

The sever 104 may be one sever or may be a group of severs. The sever 104 may store the user account hold by the smart phone 102, and store various smart devices that are associated with the user account. In some embodiments, the sever 104 is the sever that providing the corresponding service for the home application scenario on network side.

In some embodiments, the home application scenario may also include a wireless router 108. The wireless router 108 provides the WiFi environments for various smart devices in a home environment.

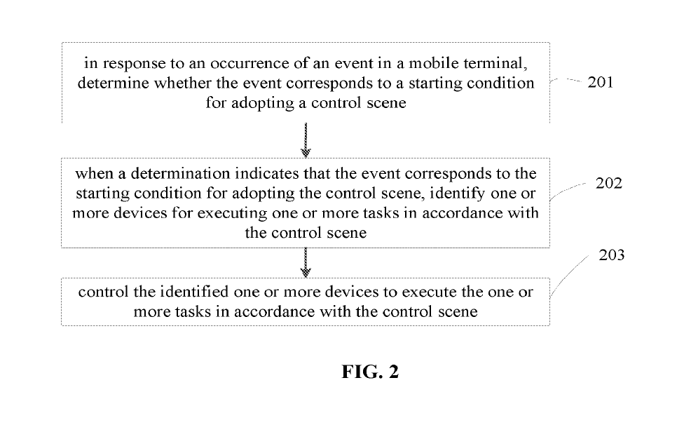

FIG. 2 is a flow chart illustrating a method for controlling devices according to an example embodiment of the disclosure. As shown in FIG. 2, the method for controlling devices can be applied in the smart home client or the sever 104. In some embodiments, the smart home client described herein in practice may be installed into the smart phone 102 shown in FIG. 1, or may be installed into the other smart device. The method for controlling devices including:

In step 201, when an event occurs in a smart phone, detecting whether the event corresponds to a starting condition in a control scene, where the control scene includes one or more starting conditions and tasks corresponding to the starting conditions. The starting conditions and the tasks are set in accordance with events in the smart phone and the tasks being executed by one or more executing devices.

In step 202, if the event corresponds to one of the starting conditions in the control scene, identifying one or more executing devices corresponding to the starting condition in the control scene;

In step 203, controlling the one or more executing devices to execute a task in the control scene.

In conclusion, a method for controlling devices provided in the present disclosure, with controlling the executing device to execute the corresponding task when the event occurs in the smart phone by associating that with the actions of the executing device. Since the smart phone may be associated with multiple executing devices, the executing device associated with the smart phone may execute the corresponding task in accordance with a control scene in response to the event occurs in the smart phone. Therefore, the smart phone can control every executing device effectively without manual controlling each device individually. Thus it will solve the problem that cumbersome controlling process caused by every device run independently and need manual independent controlling; achieve that the smart phone may be interacted with other devices, to realize the controlling automation without manual controlling.

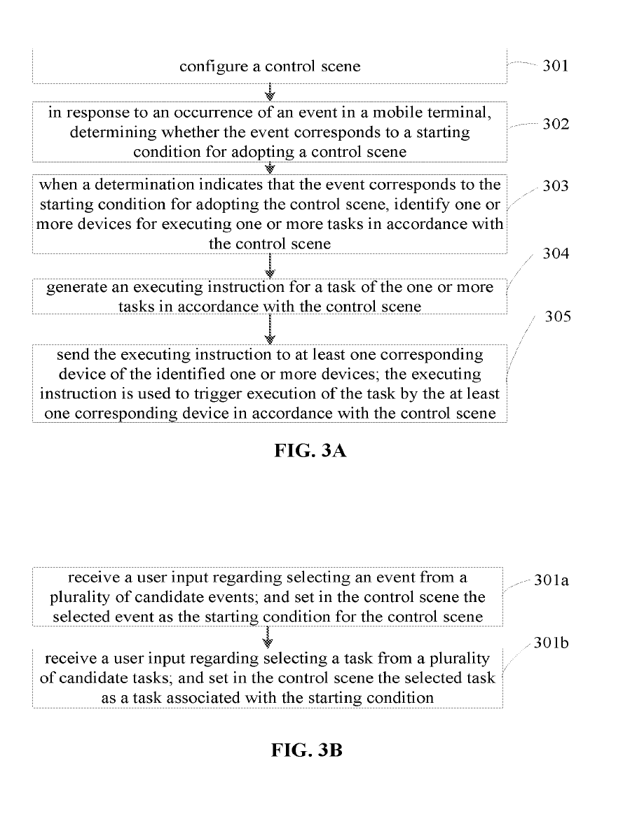

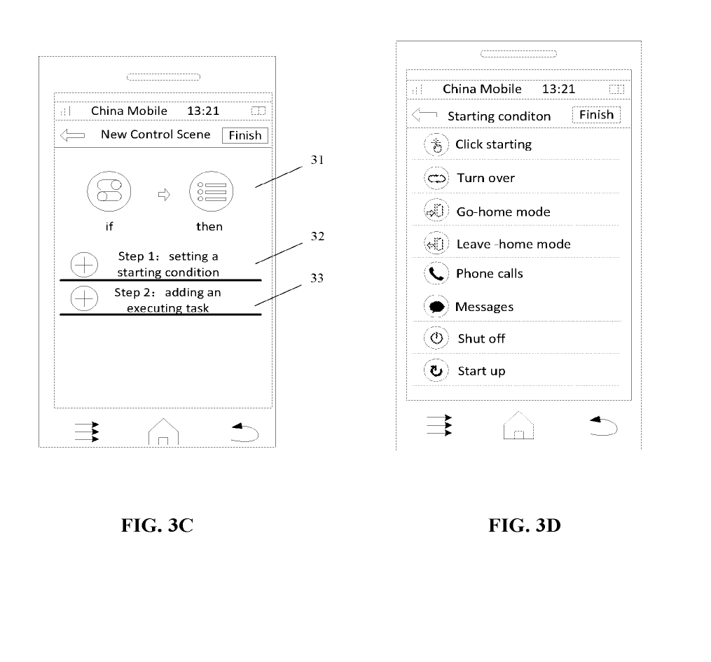

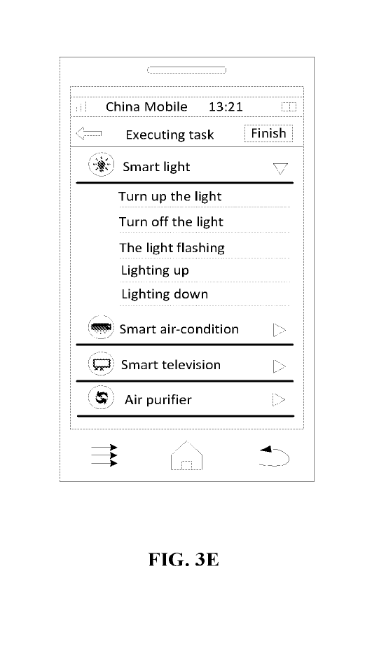

FIG. 3A is a flow chart illustrating a method for controlling devices according to another example embodiment of the disclosure. As shown in FIG. 3A, the method for controlling devices is applied in the smart home client or the sever 104. The smart home client described herein in practice may be installed into the smart phone 102 shown in FIG. 1, or may be installed into the other smart device. The method for controlling devices including:

In step 301, the control scene is configured.

The control scene described herein includes the starting condition set with the events in the starting device and the tasks executed by the smart phone that corresponding to the starting condition. In some embodiments, every control scene includes two parts, one is one or more starting conditions and another is one or more tasks to be executed when the one or more starting conditions is satisfied.

In the present embodiment, the device corresponding to the starting condition is the smart phone, the device which executing the tasks is the executing device.

The executing devices described herein are generally the other various devices in the smart home, for example, the executing devices may be the another smart phone, or a smart television, smart stereo, tablet, air purifier, smart air-condition, desktop, smart gate, smart window, smart switch, socket, or the like.

In many applications, the executing devices are not limit to the various devices above, the present embodiment will not limit the specific type of the executing devices.

Referring to the steps in FIG. 3B, a process of configuring the control scene may include step 301a and step 301b.

In step 301a, after one of the events related to the smart phone is selected by a user input, the selected event is set as a starting condition in the control scene.

In a possible implementation, the user may login the smart home client with the user account, and use the control scene set by the smart home client. Generally, the user may use the smart home client which on the electronic device login the user account. The electronic device herein may be the smart phone, tablet, etc. When the user login the smart home client with the user account successfully, the client can obtain the related information of the user account logged in from the sever, which include the information about the smart phone and the other various devices associated with the user account, and the events of the smart phone and the tasks of the other various devices which are provided. In some embodiments, the smart device is referred to as the executing device when used to set the control scene.

In the processing of configuring the control scene, the smart home client shows the entry for setting the starting condition and tasks of the control scene within the user interface for setting the control scene. FIG. 3C is a diagram illustrating a user interface for configuring a control scene according to an example embodiment of the disclosure. In FIG. 3C, the user interface 31 provides the setting entry 32 for setting the starting condition of the control scene and the setting entry 33 for setting the tasks of the control scene.

When the user triggers the entry for setting the starting condition of the control scene in the setting interface, the smart home client may display the various events of the smart phone associated with the user account. The events of the smart phone include receiving an incoming call, hanging up an incoming call, receiving a short message, replying a short message, shutting off, restarting, turning up a volume, turning down a volume, starting a silent mode, closing a silent mode, starting an airplane mode, or closing an airplane mode, or events determined by parameters sensed by sensors in the smart phone, and the parameters may include a light intensity, a volume, an acceleration, or an angular acceleration. The events of the smart phone may also be the event that triggered by image sensor, fingerprint identification sensor, electro-optical sensor, acceleration sensor, gravity sensor, distance sensor, direction sensor, or the like, or, for example, identifying someone by taking photos, identifying someone with fingerprint identification, clicking the smart phone, swing the smart phone up and down, swing the smart phone left and right, turning-over the smart phone, inclining the smart phone in certain angle (for example, 90 degree), or the like.

FIG. 3D is a diagram illustrating a user interface for setting a starting condition in a control scene according to an example embodiment of the disclosure. In FIG. 3D, the events of the smart phone displayed within the setting interface of the starting condition include: setting the phone turned over, at home mode, leave home mode, calls, messages, shut off, start up, etc. The user can select one from these events as the starting condition of the control scene. That is, the starting condition is an occurrence of the selected event.

Generally, after one of the events related to the smart phone is selected, the smart phone may generate one condition selecting instruction, the condition selecting instruction is used to indicate that the selected event is determined to be the starting condition of the control scene, and the event which the selecting instruction has indicated is set as the starting condition of the control scene.

In step 301b, after one of the tasks related to the executing device is selected by a user input, the selected task is set as a task in the control scene.

When the user triggers the entry for setting the task in the user interface, the smart home client may display the various tasks of the various executing device associated with the user account. The different executing devices may correspond to the same task or different tasks. In some embodiments, the task of the executing device is related to the performance, type, and the like of the smart phone.

For a smart light, for example, the tasks executable by the smart light include turning on the light, turning off the light, or light flashing.

For an air purifier, for another example, the tasks executable by the air purifier include starting up cleaning function, staring up sleeping function, or indicator lamp flashing.

FIG. 3E is a diagram illustrating a user interface for setting a task in a control scene according to an example embodiment of the disclosure. In FIG. 3E, the various smart devices and the to-be-executed tasks of the various smart devices are displayed in the user interface of the to-be-executed tasks, for example, the tasks which the smart light corresponding to, including: turning on the light, turning off the light, light flashing, lighting up, or lighting down. There are other smart devices in the user interface, such as smart air-condition, smart television, and air purifier, and the user may trigger the entries of these smart devices, so that the triggered tasks which the smart light corresponding to are displayed on the smart phone.

It should note that the smart device which is set for executing the task in control scene is referred to as the executing device.

Generally, after one of the tasks related to the executing device is selected, the smart phone may generate one task selecting instruction, the task selecting instruction is used to indicate that the task which the selected smart device can execute is determined to be the task of the control scene, the task which the task selecting instruction has indicated is set as the task which executed by the executing device in the control scene.

In some embodiments, both various events of the smart phone and the various tasks of the smart device which displayed on the smart home client are predetermined. In other embodiments, the various events of the smart phone and the various tasks of the smart device which displayed on the smart home client may be based on the recommendation from the client to the server.

According to step 301a and step 301b, the user may implement the configuration of the control scene as desire.

For example, when the user brings the smart phone home, the smart air condition can be started in accordance with a control scene. At this time, the starting condition of the control scene set by user may be that the smart phone is in home mode, and the task of the control scene is starting up the smart air condition.

For another example, when the smart phone is shut off, it generally means the user is going to sleep. At this time, the starting condition of the control scene set by user may be that the smart phone is shut off, and the task of the control scene is turning off the smart light.

In actually applications, the user may combine the common events of the smart phone as necessary to associate the other smart device, so that it can implement the interaction in different scenarios.

In some embodiments, the order of performing the step 301a and 301b can exchange. Therefore, the user may set the control scene according to the actual demand. For example, it may either set one control scene or set two or more control scenes.

In one possible scenario, a unique identifier may be generated for each control scene when configuring the control scenes in order to distinguish them. The starting conditions and tasks executed by the executing device of the control scenes may refer to the table 1 below:

TABLE 1
The setting of the starting conditions and the associated tasks

| Identifier of the | | |
|---|---|---|
| control scene | Starting conditions | The associated tasks |
| 1 | Smart phone calls | Smart light flashing lightly |
| 2 | Smart phone messages | WiFi speaker producing a short |
| | | alert tone |
| 3 | Smart phone shuts off | Turn off all of smart devices in |
| | | living room |
| . . . | . . . | . . . |

Additionally, the starting conditions of the control scenes may the operation for the smart phone, the corresponding starting conditions and tasks executed by the executing device of the control scenes may refer to the table 2 below:

TABLE 2
The setting of the starting conditions and the associated tasks

| Identifier | | |
|---|---|---|
| of the control | | |
| scene | Starting conditions | The associated tasks |
| 1 | Click the smart phone | Start up or shut off any of the |
| | | smart devices |
| 2 | Turn-over the smart | Smart light flashing, smart air |
| | phone or swing the smart | condition switching modes, |
| | phone up and down, left | smart television switching |
| | and right | channels |
| 3 | Incline the smart phone | Turn up or turn down the |
| | in certain angle | volume of the smart |
| | | television |
| 4 | Identify someone by | Start up or shut off smart |
| | taking photos or identify | security system |
| | someone with fingerprint | |
| | identification, verify the | |
| | user identification | |
| . . . | . . . | . . . |

In step 302, when an event occurs that in a smart phone, detecting whether the event is a starting condition of a control scene.

When detecting the event occurs in the smart phone, the different events are corresponding to the different detecting method.

For the example that the event in the control scene is that the smart phone is in the go-home mode. In one example, if the smart phone is found that it has been connected with the wireless router at home, it means the smart phone is in the go-home mode. In another example, in accordance with the location data of the geographic position for the smart phone, if the geographic position for the smart phone has been determined is close to home, it means the smart phone is in the go-home mode.

For another example that event in the control scene is that the smart phone is in the leave-home mode. In one example, if the smart phone is found that it has been disconnected with the wireless router at home, it means the smart phone is in the leave-home mode. In another example, in accordance with the location data of the geographic position for the smart phone, if the geographic position for the smart phone has been determined is far away from home, it means the smart phone is in the leave-home mode.

For another example that the smart phone calls, if the system of the smart phone has monitored the calls, it can inform the results to the smart home client, and the smart home client can determine that there are calls for the smart phone.

When the event occurs in the smart phone has been determined, then it can detect whether the event is the starting condition of the control scene which has been set. Alternatively, the control scene which has been set by the user may be synchronized to the server, after the server has received the control scene which has been set by the user, the control scene and the user account may be stored correspondingly. When the user account logged on the smart home client, the various control scenes corresponding to the user account can be obtained from the server and that may be displayed on the smart home client.

In step 303, an executing device corresponding to the starting condition in the control scene is identified if the event is one of the starting conditions in the control scene.

Alternatively, if the smart home client is stored with various control scenes, the starting condition can be used to identify a corresponding control scene, and the executing device corresponding to the starting condition can be identified in accordance with the control scene.

In step 304, generating an executing instruction in accordance with the task in the control scene.

The smart home client in the smart phone may generate the executing instruction in accordance with the task in the control scene, in order to ensure that the executing device can execute the corresponding task. For example, when the task that has been set is turn off the light, the executing instruction may be the closing instruction.

After the smart home client in the smart phone has determined that the event of the smart phone occurs and the control scene of which the start condition is that event, it can query the executing device in the control scene and the task to be executed by the executing device. According to the task to be executed by the executing device, generating an executing instruction for the executing device which can identify the task correctly.

In the step 305, the executing instruction is sent to the executing device, wherein the executing instruction is used to trigger the execution of the task in the control scene by the executing device.

The smart home client can either send the executing instruction to the executing device directly, or send the executing instruction to the device on network side then this device forward it to the executing device.

In conclusion, the method for controlling devices provided in the present disclosure, with controlling the executing device to execute the corresponding task when the event occurs in the smart phone by associating that with the actions of the executing device. Since the smart phone may be associated with multiple executing devices, the executing device associated with the smart phone may execute the corresponding tasks according to the event occurs in the smart phone, so that the smart phone may control every executing device effectively without manual controlling each device individually. Thus, it will solve the problem that cumbersome controlling process caused by every device run independently and need manual independent controlling, and achieve that the smart phone may be interacted with other devices to realize the controlling automation without manual controlling.

The method for controlling devices provided in the present disclosure, further with that after the determination of the task of the control scene, informing the executing device for the task in order to enable the executing device to execute the task in the control scene. Since the executing instructions may be generated in accordance with the task in the control scene automatically and sent to the executing device directly, it will ensure that control the executing device automatically to execute the task set in the control scene and the possibilities to implement the controlling of the executing device in automation.

The method for controlling devices provided in the present disclosure, further with that setting the starting condition for the control scene with the events related to the smart phone, setting the task for the control scene with the tasks related to the executing device, so that implement the interaction between the smart phone and the executing device. The users may select in accordance with the events and tasks which are provided and set the control scene as desired, it will enable the setting of control scene more conform with the requirements of the users.

The method for controlling devices provided in the present disclosure, further with that setting the types of the events in the smart phone. In some embodiments, these events in the smart phone generally have a stronger association with the other subsequent operations in actual life, so that the implementation of the control scene is more abundant and more fit with the usage habits of the users to enable the home life become more intelligent.

In some embodiments, the step 302-305 may also be used in the devices on the network side. That is, when the event occurs in the smart phone, sending the events of the smart phone or the information describing the event in the smart phone which has happened to the device on the network side with the user account. If the event is one of the starting condition in the control scene, the device on the network side determine the executing device which corresponding to the starting condition in the control scene, generating the executing instructions in accordance with the tasks which have been set in the control scene, and sending the executing instructions to the executing device.

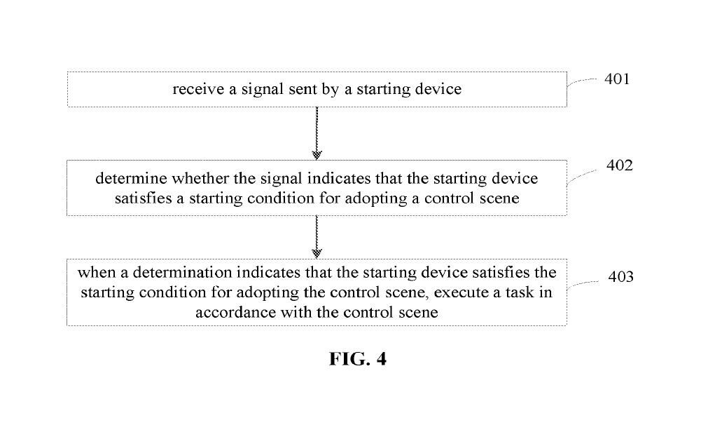

FIG. 4 is a flow chart illustrating a method for executing a task in accordance with a control scene according to another example embodiment of the disclosure. As shown in FIG. 4, the method for executing a task in accordance with a control scene is applied in the smart home client or the sever 104. In some embodiments, the smart home client described herein in practice may be installed into the smart phone 102 shown in FIG. 1, or may be installed into the other smart device. The method for method for executing a task in accordance with a control scene may include the following steps.

In step 401, receiving a signal sent by a starting device.

In step 402, determining whether the signal indicates that the starting device satisfies a starting condition for adopting a control scene. The control scene comprises starting conditions and tasks corresponding to the starting conditions, and the starting conditions and the tasks being set in accordance with events in the starting device and the tasks being executed by an apparatus, such as a smart phone.

In step 403, when a determination indicates that the starting device satisfies one of the starting conditions for adopting the control scene, a task is executed in accordance with the control scene.

In conclusion, the method for executing a task in accordance with a control scene provided in the present disclosure includes controlling the smart phone to execute the corresponding task when the event occurs in the starting device by associating that with the actions of the smart phone. Since multiple executing devices may be associated with the smart phone, the smart phone may execute the corresponding tasks associated to the events based on the event occurs in the starting device, so that it will control the smart phone effectively without manual controlling. Thus it will solve the problem that cumbersome controlling process caused by every device run independently and need manual independent controlling, and achieve that the smart phone may be interacted with other devices, to realize the controlling automation without manual controlling.

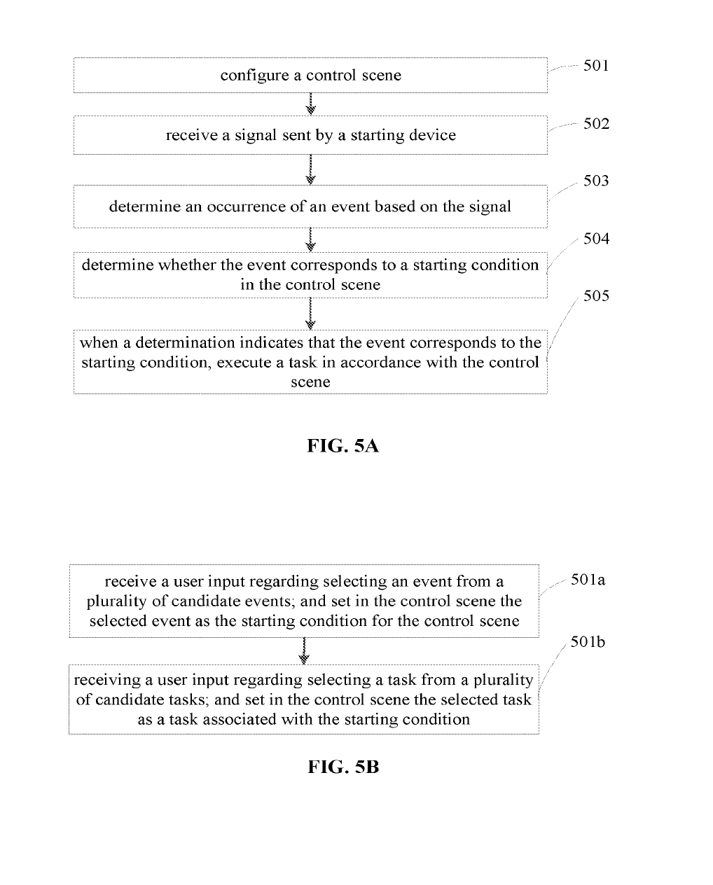

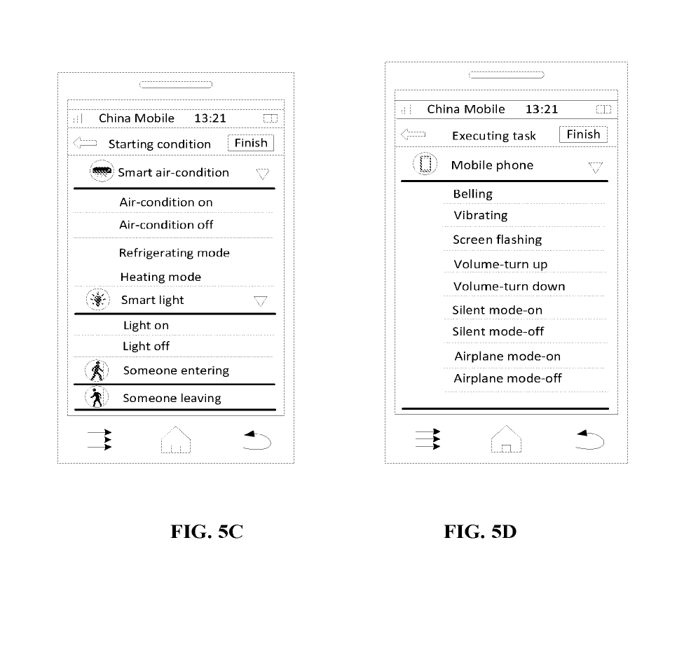

FIG. 5A is a flow chart illustrating a method for executing a task in accordance with a control scene according to another example embodiment of the disclosure. As shown in FIG. 5A, the method for executing a task in accordance with a control scene is applied in the smart home client or the sever 104. In some embodiments, the smart home client described herein in practice may be installed into the smart phone 102 shown in FIG. 1, or may be installed into the other smart device.

In step 501, the control scene is configured.

The control scene described herein includes the starting conditions set with the events in the starting device, and the tasks executed by the smart phone that corresponding to the starting conditions.

In the present embodiment, the device corresponding to the starting condition is the smart phone, the device which executing the tasks is the executing device.

The executing devices described herein are generally the other various devices in the smart home, for example, the executing devices may be the other smart phone, smart television, smart stereo, tablet, air purifier, smart air-condition, desktop, smart gate, smart window, smart switch or socket and the like.

In some embodiments, the executing devices are not limit to the various devices above, the present embodiment will not limit the specific type of the executing devices.

Referring to the steps in FIG. 5B in a process of configuring the control scene.

In step 501a, after one of the events related to the smart phone is selected by a user input, the selected event is set as a starting condition in the control scene.

In a possible implementation, the user may login the smart home client with the user account, and use the control scene set by the smart home client. Generally, the user may use the smart home client which on the electronic device login the user account. The electronic device herein may be the smart phone, tablet, etc. When the user login the smart home client with the user account successfully, the client can obtain the related information of the user account logged in from the sever, which include the information about the smart phone and the other various devices bonded with the user account, and the events of the smart phone and the tasks of the other various devices which are provided, herein the smart device is referred to as the executing device when used to set the control scene.

It should be noted that the above application scenario is only exemplary, and the present disclosure is not limited thereto.

In the processing of setting the control scene, the smart home client shows the entry for setting the starting condition and tasks of the control scene within the user interface of the control scene. Still referring to FIG. 3C.

When the user triggers the entry for setting the task in the setting interface, the smart home client may display the various events of the various smart device associated with the user account. Different smart devices may correspond to the same event or different events, where the event of the smart device is related to the performance, type and the like of the smart phone.

For a smart light, for example, the events that the smart light corresponds to may include: turning on the light, turning off the light, or light flashing.

For an air purifier, for another example, the events that the air purifier corresponds to may include: starting up cleaning function, staring up sleeping function, or indicator lamp flashing.

FIG. 5C is a diagram illustrating a user interface for setting a starting condition in a control scene according to another exemplary embodiment. In FIG. 5C, the various smart devices and the events of the various smart devices are displayed in the user interface of the starting condition. For example, the events which the smart light corresponds to may include: the light on, the light off. For another example, the events which the smart air-condition corresponds to may include: air-condition on, air-condition off, refrigerating mode, heating mode. The setting user interface also includes other events, such as, someone entering, someone leaving.

In some embodiments, the event “someone entering” and “someone leaving” are also determined based on the status parameters collected by the smart device.

It should note that the smart device which is set for executing the starting condition in control scene is referred to as the starting device.

Generally, after one of the events related to the executing device is selected, the smart phone may generate one condition selecting instruction. The condition selecting instruction is used to indicate that the event which the selected smart device can execute is determined to be the starting condition of the control scene, and the event of the smart device which the condition selecting instruction has indicated is set as the starting condition of the executing device in the control scene.

In step 501b, after one of the tasks related to the smart phone is selected by a user input, setting the selected task as a task in the control scene.

When the user triggers the entry for setting the task in the setting interface, the smart home client may display the tasks of the smart phone associated with the user account.

FIG. 5D is a schematic diagram illustrating a setting interface for setting a task in a control scene according to another example embodiment of the disclosure. In FIG. 5D, the tasks of the smart phone displayed in the user interface, including: belling, vibrating, screen flashing, volume-turn up, volume-turn down, silent mode-on, silent mode-off, airplane mode-on, airplane mode-off. The user may select anyone of these tasks as the task of the control scene.

Generally, after one of the tasks related to the smart phone is selected by a user input, the smart phone may generate one task selecting instruction. The task selecting instruction is used to indicate that the task in the selected smart device is determined to be the task of the control scene, and the task which the task selecting instruction has indicated is set as the task of the control scene.

in some embodiments, the tasks in the smart phone include shutting off, receiving an incoming call, displaying an unread message, restarting, turning up a volume, turning down a volume, starting a silent mode, closing a silent mode, starting an airplane mode, and closing an airplane mode, and the other tasks shown in FIG. 5D. In some embodiments, the tasks may also be the tasks which implemented by the other smart phone, and the present disclosure are not limit for the tasks in smart phone.

It is worthy to be note that both various events of the smart phone and the various task of the smart device which displayed on the smart home client are predetermined. Certainly, the various tasks of the smart phone and the various events of the smart device which displayed on the smart home client may be based on the recommendation from the client to the server.

According to step 501a and step 501b, the user may implement the setting of the control scene as desire.

For example, when the smart television is playing a video, it can turn up the volume of the smart phone, at this time, the starting condition of the control scene set by the user may be that the smart television is playing the video, and the task of the control scene is turning up the volume of the smart phone.

For another example, when the smart light is turn off, the user wants know where the phone is, at this time, the starting condition of the control scene set by user may be that the smart light is turn off, and the task of the control scene is enabling the smart phone screen flashing.

In step 502, a signal sent by a starting device is received, where the signal carries the parameters for determining whether an event occurs in the starting device.

Generally, when some event occurs in the staring device, it will obtain the parameters to determine the event that happened correspondingly.

For example, when the air purifier is cleaning the air, it will obtain the air quality parameters that have been collected correspondingly.

For another example, when the air condition is in heating mode, it will obtain the parameters which indicate the air condition is in heating mode correspondingly.

When the starting device determines the event that has happened, it will send the signal which is corresponding to the event to the smart phone or smart home client, or send it to the devices on the network side and forward it to the smart phone by the devices on the network side. The signal generally carries a parameter for determining an event in the starting device.

In step 503, the event occurring in the starting device is determined in accordance with the parameter carried in the signal.

There are different events in different starting devices, such as starting up, shutting off, restarting, starting a refrigeration mode, starting a heating mode, detecting someone entering or detecting someone leaving.

In step 504, whether the event corresponds to the starting condition in the control scene is determined.

In step 505, if the starting device satisfies one of the starting conditions in the control scene, a task set in the control scene is executed.

In conclusion, the method for controlling devices provided in the present disclosure, with controlling the smart phone to execute the corresponding task when the event occurs in the starting device by associating that with the actions of the smart phone. Since multiple executing devices may be associated with the smart phone, the smart phone may execute the corresponding tasks associated to the event in accordance with the event occurs in the starting device, so that it will control the smart phone effectively without manual controlling. Thus it will solve the problem that cumbersome controlling process caused by every device run independently and need manual independent controlling, and achieve that the smart phone may be interacted with other devices, to realize the controlling automation without manual controlling.

The method for controlling devices provided in the present disclosure includes determining the event occurring in the starting device in accordance with the parameter carried in the signal which sent by the starting device, and then determining whether there is the control scene with the starting condition based on the event. In some embodiments, since it can determine the event occurs in the starting device after learning of the starting device, it can ensure the smart phone executes the task corresponding to the signal correctly.

The method for controlling devices provided in the present disclosure includes setting the starting condition for the control scene with the events related to the starting device, setting the task for the control scene with the tasks related to the smart phone. The users may select in accordance with the events and tasks and set the control scene as desired, and it will enable the setting of the control scene more conform with the requirements of the users.

In some embodiments, the tasks in the smart phone generally have a stronger association with the other events in actual life, so that the implementation of the control scene is more abundant and more fit with the usage habits of the users, to enable the home life become more intelligent.

The following is the embodiments of the apparatus which can execute the embodiments of the method of the present disclosure. For the details that are not disclosed in the embodiments of the apparatus, please refer to the embodiments of the method.

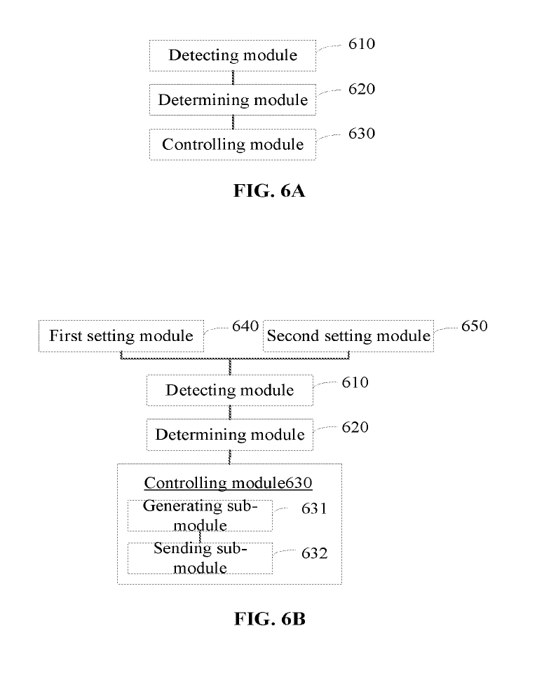

FIG. 6A is a block diagram illustrating an apparatus for controlling devices according to an example embodiment of the disclosure. As shown in FIG. 6A, the apparatus for controlling devices is applied in the smart home client or the sever 104, the smart home client described herein may be installed into the smart phone 102 in practice environments shown in FIG. 1, or may be installed into the other smart device. The apparatus for controlling devices includes a detecting module 610, a determining module 620, and a controlling module 630.

The detecting module 610 is configured to, when an event occurs in a smart phone, detect whether the event corresponds to a starting condition in a control scene. In some embodiments, the control scene comprises starting conditions and tasks corresponding to the starting conditions, the starting conditions and the tasks being set in accordance with events in the smart phone and the tasks being executed by executing devices.

The determining module 620 is configured to, if the event detected by the detecting module 610 corresponds to one of the starting conditions in the control scene, identify an executing device corresponding to the starting condition in the control scene.

The controlling module 630 is configured to control the executing device determined by the determining module 620 to execute a task in accordance with the control scene.

In a possible implementation, referring to FIG. 6B, which is a block diagram illustrating an apparatus for controlling devices according to another example embodiment of the disclosure, the controlling module 620 includes a generating sub-module 631 and a sending sub-module 632.

The generating sub-module 631 is configured to generating an executing instruction in accordance with the task in the control scene.

The sending sub-module 632 is configured to send the executing instruction generated by the generating sub-module 631 to the executing device, and the executing instructions are used to trigger the execution of the task in the control scene by the executing device.

In a possible implementation, referring to FIG. 6B, the apparatus for controlling devices further includes: a first setting module 640 and a second setting module 650.

The first setting module 640 is configured to, in a process of setting the control scene, after one of the events related to the starting device is selected, set the selected event as a starting condition in the control scene.

The second setting module 650 is configured to, in the process of setting the control scene, after one of the tasks related to the smart phone is selected, set the selected task as a task in the control scene.

In a possible implementation, the events are receiving an incoming call, hanging up an incoming call, receiving a short message, replying a short message, shutting off, restarting, turning up a volume, turning down a volume, starting a silent mode, closing a silent mode, starting an airplane mode, closing an airplane mode or events determined by parameters sensed by sensors in the smart phone, wherein the parameters are a light intensity, a volume, an acceleration and an angular acceleration.

In conclusion, the apparatus for controlling devices provided in the present disclosure is configured to control the executing device to execute the corresponding task when the event occurs in the smart phone by associating that with the actions of the executing device. Since the smart phone may be associated with multiple executing devices, the executing device associated with the smart phone may execute the corresponding task based on the event occurs in the smart phone, so that it will control every executing device effectively without manual controlling. Thus, it will solve the problem that cumbersome controlling process caused by every device run independently and need manual independent controlling, and achieve that the smart phone may be interacted with other devices, to realize the controlling automation without manual controlling.

The apparatus for controlling devices provided in the present disclosure can, after the determination of the task of the control scene, inform the executing device for the task in order to enable the executing device to execute the task set in the control scene. Since the executing instructions may be generated in accordance with the task set in the control scene automatically and sent to the executing device directly, it will ensure that control the executing device automatically to execute the task set in the control scene and the possibilities to implement the controlling of the executing device in automation.

The apparatus for controlling devices provided in the present disclosure is configured to set the starting condition for the control scene with the events related to the smart phone which are provided, and set the task for the control scene with the tasks related to the executing device which are provided, so that implement the interaction between the smart phone and the executing device. The users may select in accordance with the events and tasks which are provided and set the control scene as desired, it will enable the setting of control scene more conform with the requirements of the users.

The apparatus for controlling devices provided in the present disclosure is configured to set the types of the events in the smart phone, where these events in the smart phone generally have a stronger association with the other subsequent operations in actual life, so that the implementation of the control scene is more abundant and more fit with the usage habits of the users to enable the home life become more intelligent.

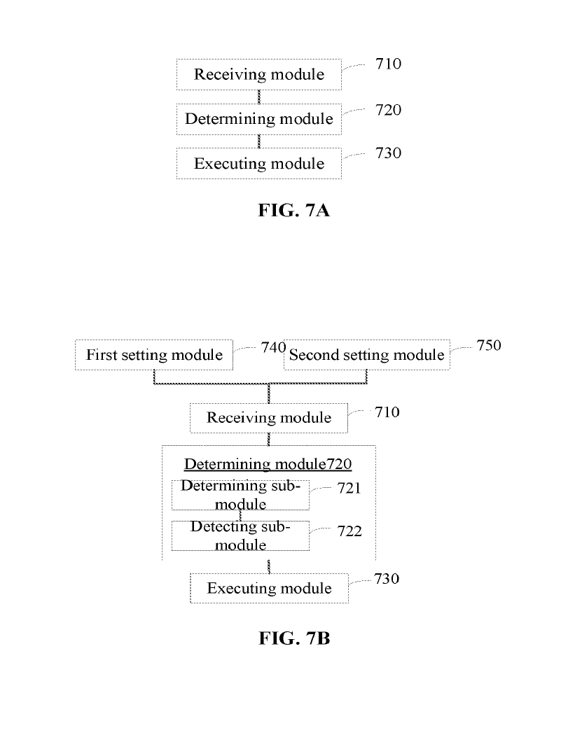

FIG. 7A is a block diagram illustrating an apparatus for executing a task in accordance with a control scene according to another example embodiment of the disclosure. As shown in FIG. 7A, the apparatus for executing a task in accordance with a control scene is applied in the smart home client or the sever 104, and the smart home client described herein in practice may be installed into the smart phone 102 shown in FIG. 1, or may be installed into the other smart device. The apparatus for controlling devices includes a receiving module 710, a determining module 720, and an executing module 730.

The receiving module 710 is configured to receive a signal sent by a starting device.

The determining module 720 is configured to determine whether the signal received by the receiving module 710 indicates that the starting device satisfies a starting condition in a control scene. In some embodiments, the control scene includes starting conditions and tasks corresponding to the starting conditions, and the starting conditions and the tasks being set in accordance with events in the starting device and the tasks being executed by a smart phone.

The executing module 730 configured to execute a task in accordance with the control scene if the determining module 720 determines that the staring device satisfies one of the starting conditions in the control scene.

FIG. 7B is a block diagram illustrating an apparatus for executing a task in accordance with a control scene according to another example embodiment of the disclosure. In a possible implementation, in FIG. 7B, the apparatus further includes a determining sub-module 721 and a detecting sub-module 722.

The determining sub-module 721 is configured to determine the event occurring in the starting device in accordance with the parameter carried in the signal received by the receiving module 710, where the events may include starting up, shutting off, restarting, starting a refrigeration mode, starting a heating mode, detecting someone entering or detecting someone leaving.

The detecting sub-module 722 is configured to detect whether the event determined by the determining sub-module 721 is the starting condition in the control scene.

In a possible implementation, referring to FIG. 7B, the apparatus for controlling devices further includes a first setting module 740 and a second setting module 750.

The first setting module 740 is configured to, in a process of setting the control scene, after one of the events related to the starting device is selected, set the selected event as a starting condition in the control scene;

The second setting module 750 is configured to, in the process of setting the control scene, after one of the tasks related to the smart phone is selected, set the selected task as a task in the control scene.

In a possible implementation, the tasks may include shutting off, receiving an incoming call, displaying an unread message, restarting, turning up a volume, turning down a volume, starting a silent mode, closing a silent mode, starting an airplane mode, and closing an airplane mode.

In conclusion, the apparatus for controlling devices provided in the present disclosure, with controlling the smart phone to execute the corresponding task when the event occurs in the starting device by associating that with the actions of the smart phone. Since multiple executing devices may be associated with the smart phone, the smart phone may execute the corresponding tasks associated with the event in accordance with the event occurs in the starting device, so that it will control the smart phone effectively without manual controlling. Thus, it will solve the problem that cumbersome controlling process caused by every device run independently and need manual independent controlling, and achieve that the smart phone may be interacted with other devices, to realize the controlling automation without manual controlling.

The apparatus for controlling devices provided in the present disclosure is configured to determine the event occurring in the starting device in accordance with the parameter carried in the signal, and then determine whether there is the control scene with the starting condition based on the event. Since it can determine the event occurred in the starting device after learning of the starting device, it can ensure the smart phone executes the task corresponding to the signal correctly.

The apparatus for controlling devices provided in the present disclosure is configured to set the starting condition for the control scene with the events related to the starting device which are provided, and set the task for the control scene with the tasks related to the smart phone which are provided, so that implement the interaction between the starting device and the smart phone. The users may select in accordance with the events and tasks which are provided and set the control scene as desired, it will enable the setting of the control scene more conform with the requirements of the users.

The apparatus for controlling devices provided in the present disclosure is configured to set the types of the events in the smart phone, and these tasks in the smart phone generally have a stronger association with the other events in actual life, so that the implementation of the control scene is more abundant and more fit with the usage habits of the users, to enable the home life become more intelligent.

With respect to the devices in the above embodiments, the specific manners that the respective modules perform operations have been described in detail in the embodiments regarding the relevant methods, and will not be elaborated herein.

An apparatus for controlling devices is provided in an exemplary embodiment of the present disclosure. It can implement the method for controlling the device, or the method for executing a task in the smart home client or the devices on the network side. In some embodiments, the apparatus for controlling the device includes a processor and a memory for storing instructions executable by the processor. The processor is configured to: when an event occurs in a smart phone, detect whether the event corresponds to a starting condition in a control scene. The control scene comprises starting conditions and tasks corresponding to the starting conditions, and the starting conditions and the tasks are set in accordance with events in the smart phone and the tasks being executed by executing devices. In some embodiments, if the event corresponds to one of the starting conditions in the control scene, an executing device corresponding to the starting condition in the control scene is identified, and the executing device is controlled to execute a task in accordance with the control scene.

An apparatus for controlling devices is provided in another exemplary embodiment of the present disclosure. In some embodiments, it can implement the method for controlling the device, and the method for controlling the device is applied in the smart home client or the devices on the network side. In some embodiments, the apparatus for controlling the device includes a processor and a memory for storing instructions executable by the processor. The processor is configured to: receive a signal sent by a starting device; determine whether the starting device satisfies a starting condition in a control scene in accordance with the signal, wherein the control scene comprises starting conditions and tasks corresponding to the starting conditions, the starting conditions and the tasks being set in accordance with events in the starting device and the tasks being executed by a smart phone; and execute a task in the control scene if the staring device satisfies one of the starting conditions in the control scene.

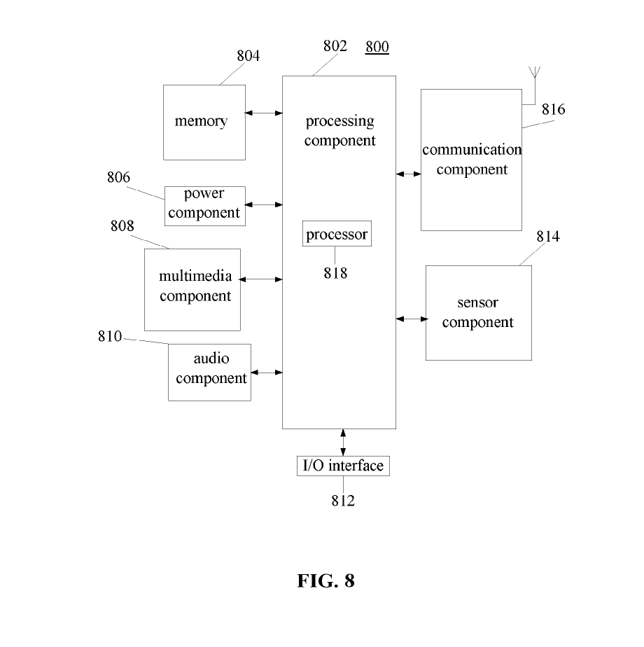

FIG. 8 is a block diagram illustrating an apparatus for controlling devices according to an exemplary embodiment. For example, the apparatus 800 may be the smart device installed with smart home client.

Referring to FIG. 8, the apparatus 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the apparatus 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the apparatus 800. Examples of such data include instructions for any applications or methods operated on the apparatus 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the apparatus 800. The power component 806 may include a power management system, one or more power sources, and any other components associated with the generation, management, and distribution of power for the apparatus 800.

The multimedia component 808 includes a screen providing an output interface between the apparatus 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the apparatus 800 is in an operation mode, such as a photographing mode or a video mode. Each of the front camera and the rear camera may be a fixed optical lens system or have optical focusing and zooming capability.

The audio component 810 is configured to output and/or input audio signals. For example, the audio component 810 includes a microphone (“MIC”) configured to receive an external audio signal when the apparatus 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, the peripheral interface modules being, for example, a keyboard, a click wheel, buttons, and the like. The buttons may include, but are not limited to, a home button, a volume button, a starting button, and a locking button.

The sensor component 814 includes one or more sensors to provide status assessments of various aspects of the apparatus 800. For instance, the sensor component 814 may detect an open/closed status of the apparatus 800, relative positioning of components (e.g., the display and the keypad, of the apparatus 800), a change in position of the apparatus 800 or a component of the apparatus 800, a presence or absence of user contact with the apparatus 800, an orientation or an acceleration/deceleration of the apparatus 800, and a change in temperature of the apparatus 800. The sensor component 814 may include a proximity sensor configured to detect the presence of a nearby object without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the apparatus 800 and other devices. The apparatus 800 can access a wireless network based on a communication standard, such as WiFi, 2G, or 3G, or a combination thereof. In an exemplary embodiment, the communication component 816 receives a broadcast signal or broadcast associated information from an external broadcast management system via a broadcast channel. In an exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the apparatus 800, for performing the above-described methods. For example, the non-transitory computer-readable storage medium may be a ROM, a RAM, a CD-ROM, a magnetic tape, a floppy disc, an optical data storage device, and the like.

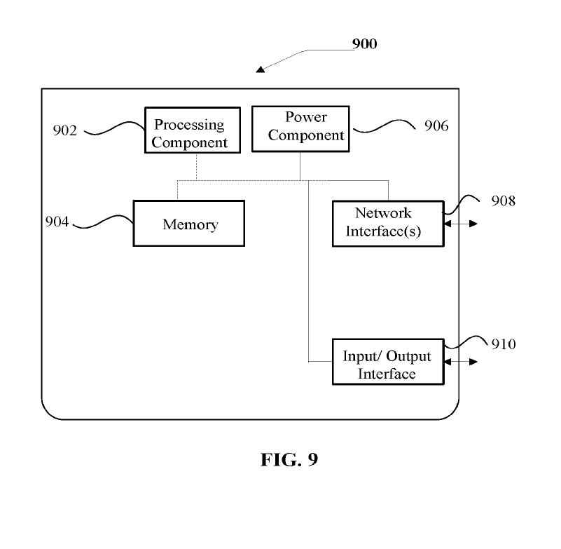

FIG. 9 is a block diagram illustrating an apparatus for controlling devices according to an exemplary embodiment. For example, the apparatus 900 may be a device on network side. Referring to FIG. 9, the apparatus 900 may include a processing component 902 (e.g. one or more processors), and the memory resource represented by a memory 904, which used to store the instructions executable by the processing component 902, such as application. The application stored in memory 904 includes one or more modules corresponding to the instructions. Additionally, the processing component 902 is configured to execute instructions, in order to execute the method for controlling the device.

The apparatus 900 may also include a power supply 906 which configured to execute the power manager of the apparatus 900, a wired or wireless network interfaces 908 which configured to connect the apparatus 900 to network, and an input/output interface 910. The apparatus 900 can be operated based on the operating systems stored in the memory 904, such as Windows Server™, Mac OS X™, Unix™, Linux™, FreeBSD™, or the like.

Other embodiments of the disclosure will be apparent to those skilled in the art from consideration of the specification and practice of the disclosures herein. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the inventive concept is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for controlling devices, comprising:
in response to an occurrence of an event in a mobile terminal, determining whether the event corresponds to a starting condition for adopting a control scene;
when a determination indicates that the event corresponds to the starting condition for adopting the control scene, identifying one or more devices for executing one or more tasks in accordance with the control scene; and
controlling the identified one or more devices to execute the one or more tasks in accordance with the control scene.

2. The method of claim 1, wherein controlling the identified one or more devices to execute the one or more tasks in accordance with the control scene comprises:
generating an executing instruction for a task of the one or more tasks in accordance with the control scene; and
sending the executing instruction to at least one corresponding device of the identified one or more devices, wherein the executing instruction is used to trigger execution of the task by the at least one corresponding device in accordance with the control scene.

3. The method of claim 1, further comprising:
receiving a user input regarding selecting an event from a plurality of candidate events;
setting in the control scene the selected event as the starting condition for the control scene;
receiving a user input regarding selecting a task from a plurality of candidate tasks; and
setting in the control scene the selected task as a task associated with the starting condition.

4. The method of claim 1, wherein the starting condition for adopting the control scene corresponds to one or more events that include receiving an incoming call, hanging up an incoming call, receiving a short message, replying a short message, shutting off, restarting, turning up a volume, turning down a volume, starting a silent mode, closing a silent mode, starting an airplane mode, or closing an airplane mode, or corresponds to one or more events determined by parameters sensed by sensors in the smart phone, the parameters including a light intensity, a volume, an acceleration, or an angular acceleration.

5. A method for controlling an apparatus, comprising:
receiving a signal sent by a starting device;
determining whether the signal indicates that the starting device satisfies a starting condition for adopting a control scene; and
when a determination indicates that the starting device satisfies the starting condition for adopting the control scene, executing a task by the apparatus in accordance with the control scene.

6. The method of claim 5, wherein
the signal indicates a parameter for determining an occurrence of an event in the starting device,
the starting condition for adopting the control scene corresponds to one or more events that include starting up, shutting off, restarting, starting a refrigeration mode, starting a heating mode, detecting someone entering, or detecting someone leaving, and
determining whether the signal indicates that the starting device satisfies the starting condition for adopting the control scene comprises determining whether the event corresponds to the starting condition for adopting the control scene.

7. The method of claim 5, further comprising:
receiving a user input regarding selecting an event from a plurality of candidate events;
setting in the control scene the selected event as the starting condition for the control scene;
receiving a user input regarding selecting a task from a plurality of candidate tasks; and
setting in the control scene the selected task as a task associated with the starting condition.

8. The method claim 5, wherein the one or more tasks comprise shutting off, receiving an incoming call, displaying an unread message, restarting, turning up a volume, turning down a volume, starting a silent mode, closing a silent mode, starting an airplane mode, or closing an airplane mode.

9. An apparatus for controlling devices, comprising:
a processor; and
a memory for storing processor-executable instructions;
wherein the processor is configured to:
in response to an occurrence of an event in a mobile terminal, determine whether the event corresponds to a starting condition for adopting a control scene;
when a determination indicates that the event corresponds to the starting condition for adopting the control scene, identify one or more devices for executing one or more tasks in accordance with the control scene; and
control the identified one or more devices to execute the one or more tasks in accordance with the control scene.

10. The apparatus of claim 9, wherein the processor is further configured to:
generate an executing instruction for a task of the one or more tasks in accordance with the control scene; and
send the executing instruction to at least one corresponding device of the identified one or more devices, wherein the executing instruction is used to trigger execution of the task by the at least one corresponding device in accordance with the control scene.

11. The apparatus of claim 9, wherein the processor is further configured to:
receive a user input regarding selecting an event from a plurality of candidate events;
set in the control scene the selected event as the starting condition for the control scene;
receive a user input regarding selecting a task from a plurality of candidate tasks; and
set in the control scene the selected task as a task associated with the starting condition.

12. The apparatus of claim 9, wherein the starting condition for adopting the control scene corresponds to one or more events that include receiving an incoming call, hanging up an incoming call, receiving a short message, replying a short message, shutting off, restarting, turning up a volume, turning down a volume, starting a silent mode, closing a silent mode, starting an airplane mode, or closing an airplane mode, or corresponds to one or more events determined by parameters sensed by sensors in the smart phone, the parameters including a light intensity, a volume, an acceleration, or an angular acceleration.

13. An apparatus, comprising:
a processor; and
a memory for storing processor-executable instructions;
wherein the processor is configured to:
receive a signal sent by a starting device;
determine whether the signal indicates that the starting device satisfies a starting condition for adopting a control scene; and
when a determination indicates that the starting device satisfies the starting condition for adopting the control scene, execute a task by the apparatus in accordance with the control scene.

14. The apparatus of claim 13, wherein
the signal indicates a parameter for determining an occurrence of an event in the starting device,
the starting condition for adopting the control scene corresponds to one or more events that include starting up, shutting off, restarting, starting a refrigeration mode, starting a heating mode, detecting someone entering, or detecting someone leaving, and
when determining whether the signal indicates that the starting device satisfies the starting condition for adopting the control scene, the processor is further configured to determine whether the event corresponds to the starting condition for adopting the control scene.

15. The apparatus of claim 13, wherein the processor is further configured to:
receive a user input regarding selecting an event from a plurality of candidate events;
set in the control scene the selected event as the starting condition for the control scene;
receive a user input regarding selecting a task from a plurality of candidate tasks; and
set in the control scene the selected task as a task associated with the starting condition.

16. The apparatus claim 13, wherein the one or more tasks comprise shutting off, receiving an incoming call, displaying an unread message, restarting, turning up a volume, turning down a volume, starting a silent mode, closing a silent mode, starting an airplane mode, or closing an airplane mode.
